(19) United States
(12) Patent Application Publication
(10) Pub. No.: US 2004/0223064 A1
(43) Pub. Date: Nov. 11, 2004

(54) Image pickup element, image pickup device, and differential amplifying circuit

(75) Inventors: Toshiaki Sato, Shizuoka (JP); Fumihiro Inui, Kanagawa (JP); Tetsuya Itano, Tokyo (JP); Masanori Ogura, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/688,997

(22) Filed: Oct. 21, 2003

(30) Foreign Application Priority Data
Oct. 24, 2002 (JP) 2002-309784
Oct. 30, 2002 (JP) 2002-316310

(51) Int. Cl. H04N 5/20

(52) U.S. Cl. 348/255

(57) ABSTRACT

An image pickup element including: a plurality of pixels that pick up an object image; a gain variable amplifying circuit that amplifies a signal from the plurality of pixels; and a semiconductor substrate on which the plurality of pixels and the gain variable amplifying circuit are formed, wherein the gain variable amplifying circuit includes a first amplifying circuit that amplifies the signal from the plurality of pixels and a second amplifying circuit that amplifies a signal from the first amplifying circuit and is connected in series with the first amplifying circuit; and wherein a gain of the first amplifying circuit is switched at every first multiple and a gain of the second amplifying circuit is switched at every second multiple different from the first multiple.

### BACKGROUND OF THE INVENTION

1. Field of the Invention

The present invention relates to an image pickup element for picking up a subject image and an image pickup device using the image pickup element.

2. Related Background Art

First, a first conventional technique will be described.

In recent years, along with improvements of function and performance of image input devices such as a digital still camera and a digital video camera, requirements for higher definition and higher sensitivity of an image pickup element used in those cameras are growing.

FIG. 1 shows an internal structure of such image pickup element. In FIG. 1, an image pickup unit 101 is composed of two-dimensionally arranged pixels 102. With respect to the operation of the image pickup element, first, the respective pixels 102 are irradiated with light and photo-signals are accumulated therein. Then, a first row V1 is selected from among two-dimensionally arranged rows by the operation of a vertical scanning circuit 103. Subsequently, the photo-signals accumulated in the respective pixels 102 on the selected row V1 are transferred through vertical output lines H1 to H5 to a line memory 104 connected with the respective vertical output lines. After that, reading switches 106 are operated in succession by the operation of a horizontal scanning circuit 105, so that the signals stored in the line memory 104 are read to a common output line 107, amplified by an amplifying circuit 108, and output from an output terminal Out. Next, a second row V2 is selected by the operation of the vertical scanning circuit 103. The above-mentioned operation is repeated.

The reading operation in the above-mentioned image pickup element will be described in detail with reference to FIGS. 2 and 3. FIG. 2 shows a circuit that reads a signal from a selected pixel 102. The circuit corresponds to the line memory 104, the reading switches 106, the common output line 107, and the amplifying circuit 110 in FIG. 1 and is shown in FIG. 2 in more detail. FIG. 3 is a timing chart in the circuit of FIG. 2.

In FIG. 2, Q1 and Q2 denote switches for transferring the output from the pixel 102 to line memories Cts and Ctn, Q3 and Q4 denote switches for reading signals from the line memories Cts and Ctn to the common output lines 107, and Chs and Chn denote reading capacitors. Each of the reading capacitors Chs and Chn is generally composed of a parasitic capacitor such as a wiring capacitor attached to each of the common output lines 107. In addition, Q5 and Q6 denote reset switches for resetting the reading capacitors Chs and Chn, 109 denotes a buffer amplifier for performing impedance conversion on the signals read to the reading capacitors Chs and Chn, and 110 denotes a subtracter which is composed of an operational amplifier 108 and resistor elements R1 and R2.

Although not shown, in the case where the photo-signal as image information is accumulated in the pixel, in order to prevent deterioration of an image quality resulting from a residual image, first, it is necessary to reset previous image information. At this time, a reset noise Vn is generated in the pixel 102. The reset noise also causes a reduction in S/N to deteriorate an image quality, so that it is necessary to remove the reset noise. In order to remove the reset noise, first, immediately after the pixel 102 is reset, the switch Q2 is turned on in accordance with a transfer pulse Ptn, so that the reset noise Vn is written into the line memory Ctn. Next, an exposure control unit such as a shutter is operated in accordance with an exposure control signal Ptv and the pixel 102 is irradiated with light to accumulate an photo-signal therein. After the photo-signal is accumulated, the switch Q1 is turned on in accordance with a transfer pulse Pts, so that an output Vs of the pixel 102 is written into the line memory Cts. At this time, the output Vs of the pixel includes the photo-signal produced by exposure and the reset noise Vn. After that, the signals stored in the line memories Cts and Ctn are read out to the reading capacitors Chs and Chn on the common output lines 107 by simultaneously turning on the switches Q3 and Q4 in accordance with an output pulse Ph from the horizontal scanning circuit. At this time, signal charges in the line memories Cts and Ctn are divided by the reading capacitors Chs and Chn. Accordingly, respective voltages in the reading capacitors Chs and Chn are obtained as follows:

Vchs=Vs ×Cts/(Cts+Chs) (1); and

Vchn=Vn×Ctn/(Ctn+Chn) (2).

The respective signals read as described above are input to the subtracter 110 through the buffer amplifiers 109 to obtain an output voltage Vout as follows:

Vout=(Vchn−Vchs)×R2/R1 (3).

Here, if Cts=Ctn=Ct and Chs=Chn=Ch,

Vout=(Vn−Vs)×(Ct/(Ct+Ch))×R2/R1 (4)

is established. Therefore, the reset noise Vn is subtracted from the photo-output Vs including a reset noise component, and then an output having preferable S/N is obtained. Next, the common output lines 107 are reset by turning on the reset switches Q5 and Q6 in accordance with a reset pulse Pchres to provide for reading of a next pixel output.

Here, as is apparent from the expression (3), a gain R2/R1 is applied to the subtracter 110 by the resistor elements R1 and R2. Therefore, since the image pickup element has a circuit block that sets the gain, in the case where high sensitive photographing of a dark subject is required in, for example, a digital still camera, a necessary image is obtained by increasing the gain. In addition, in the case of large exposure, there is a merit that it is possible to set the gain to a lower value in order to prevent a white solid of an image. A conventional gain variable amplifier in the case of such a usage is constructed as shown in FIG. 4. In FIG. 4, the reading block for reading from the line memory section to the common output lines is omitted, unlike the circuit shown in FIG. 2, and only the subtracter located after the buffer amplifiers 109 is shown. A difference between the subtracter shown in FIG. 4 and the subtracter shown in FIG. 2 is that in the subtracter shown in FIG. 4, a plurality of resistor elements are connected in series, one end of each of the switches SW is connected with each of connection portions of the resistor elements, and the other ends of the resistor elements are commonly connected with the noninverting input terminal and the inverting input terminal of the operational amplifier 108. In this structure, any of the plurality of switches SW can be selected according to a set gain value to set a resistance ratio R2/R1. Accordingly, it is possible that a signal amplitude suitable to the amount of exposure is selected and a signal is transferred to a signal processing circuit such as an A/D converter of a subsequent stage.

FIG. 5 shows an example of gain setting in a digital still camera. In the case of the digital still camera, up to now, a gain value of the gain variable amplifier, which is indicated on the ordinate (indicated by a black circle in FIG. 5), is determined such that a relationship between setting of an integral power of 2 such as two times or four times of the amount of exposure which is indicated on the abscissa and the output of the gain variable amplifier is log-linear. However, in recent years in which it is required to realize a higher quality image with wide-spreading digital cameras and improvements in the performances thereof, more precise gain setting is required. That is, it is necessary to prepare setting of, for example, 2^{1/3} times, which is indicated by a white circle in FIG. 5. Note that, for the sake of simplification, the example of switching at every 2^{1/3} times is shown in FIG. 5. However, a variable width of gain setting is arbitrary according to requirements and therefore is not limited to this value. In the case where the width of gain setting becomes narrower, the number of resistor elements and the number of switches SW become very large because it is necessary to realize all combinations of the widths by a single operational amplifier in the structure of the conventional gain variable amplifier described above in FIG. 4. For example, in the example in which gain switching is conducted at every 2^{1/3} times as shown in FIG. 5, the number of combinations between 2⁻¹ and 2³ is up to 13. Therefore, there is drawback that a sufficient response performance of the circuit is not obtained because the input capacitance of the operational amplifier becomes larger, and the occupying area of a chip becomes larger.

Next, a second conventional technique will be described.

A solid-state image pickup device is broadly divided into a CCD sensor and a MOS sensor. The CCD sensor is generally superior with respect to a point that a noise is small but has a drawback that consumption power is large. On the other hand, the MOS sensor has an advantage that consumption power is much smaller than the CCD sensor but generally has a drawback that a noise is somewhat larger than the CCD sensor. Note that there is a tendency that a noise in the MOS sensor is reducing and therefore it is expected that the MOS sensor achieves a performance equal to or higher than the CCD sensor in future.

FIG. 6 is a schematic structural diagram of a conventional MOS sensor. The MOS sensor includes a sensor array 100, a vertical shift register circuit 120, a line memory circuit 130, a horizontal shift register circuit 140, and a differential amplifying circuit 150. A plurality of photoelectric conversion elements 102 are two-dimensionally arranged in the sensor array 100. The vertical shift register circuit 120 successively selects a row from the sensor array 100. The line memory circuit 130 includes signal charge holding capacitors Cts that hold signal charges (S) from the photoelectric conversion elements of the selected row and reset level holding capacitors Ctn that hold reset levels (N) therefrom. The horizontal shift register circuit 140 successively transfers the signal charges and reset revels of one row, which are held in the line memory circuit 130, through an S-side common output line and an N-side common output line. The differential amplifying circuit 150 amplifies a differential signal of signals (signal charge and the reset revel) transferred to the S-side common output line and the N-side common output line and outputs the amplified signal.

FIG. 7 is a schematic structural diagram of the differential amplifying circuit used for the conventional MOS sensor. The differential amplifying circuit includes an input differential stage, a differential current extracting unit 250, and a current-voltage conversion unit 270. In the input differential stage, two buffer circuits 220 each having an output stage in which a MOS transistor 210 is connected to obtain a follower structure are located, a resistor element R1 is inserted between the input terminals of the buffer circuits 220 to form an input differential pair, and constant current sources composed of a MOS current mirror circuit 240 are located in the output stages of the two buffer circuits 220. The differential current extracting unit 250 extracts a differential value of output currents obtained from the drain terminals of the MOS transistors 210 in the output stages of the two buffer circuits 220. In the current-voltage conversion unit 270, a resistor element R2 is inserted between the output terminal and the negative input terminal of a differential amplifier. When the differential current obtained by the differential current extracting unit 250 is supplied to the negative input terminal of the differential amplifier, the current-voltage conversion unit 270 outputs a voltage value corresponding to the differential current in accordance with a voltage supplied to the positive input terminal of the differential amplifier.

Referring to FIG. 7, differential input voltages Vin+ and Vin− are applied to both ends of the resistor element R1 connected between the input terminals of the buffer circuits 220 and a current Ir1(=(Vin+−Vin−)/R1) thus generated is supplied to the output stages of the buffer circuits 220, so that currents Io1(=Ib1+Ir1) and Io2(=Ib2−Ir1) are obtained from the drain terminals in the output stages of the buffer circuits 220. Subsequently, a differential value of output currents (Io1−Io2=Ib1−Ib2+2×Ir1) from the two buffer circuits 220, which is obtained by the differential current extracting unit 250 is converted into an output voltage Vout(=R2×(Io1−Io2)=R2×(Ib1−Ib2+2×(Vin+−Vin−)/R1)) by the current-voltage conversion unit 270 in accordance with the voltage supplied to the positive input terminal of the current-voltage conversion unit 270 and the output voltage Vout is output therefrom. In general, with respect to Ib1 and Ib2, the constant current sources are designed such that identical current values are output, so that the output voltage determined by the resistance values of the resistor elements R1 and R2 located in the input stage and the output stage of the differential amplifying circuit and the differential input voltages, such as Vout(=2=R2/R1×(Vin+−Vin−)) are obtained.

FIG. 8 is a timing chart showing a method of driving the conventional MOS sensor. Reference symbol VD denotes a pulse for setting the start of the vertical shift register circuit, VCLK denotes a shift clock pulse for shifting shift data of the vertical shift register circuit, HD denotes a pulse for setting the start of the horizontal shift register circuit, and HCLK denotes a shift clock pulse for shifting shift data of the horizontal shift register circuit. First, the first row of a screen image is selected in accordance with the pulse VD. Subsequently, when the pulses HD and HCLK are input at the timing as shown in FIG. 8, pixels on the first row are successively read starting from the leading pixel in accordance with a pixel reading rate. Subsequently, rows are successively shifted in accordance with the pulse VCLK, so that pixels on each of the rows are successively read while the rows are shifted up to the final row of the screen image. Therefore, the pixels are read out in the horizontal direction at the pixel reading rate and read out in the vertical direction at a reading rate with a period for reading one row as a unit.

According to the differential amplifying circuit of the conventional MOS sensor as shown in FIGS. 6, 7, and 8, the constant current sources composed of the MOS current mirror circuit 240 are located in the output stages of the two buffer circuits 220, which are used for the input differential pair. A random noise such as a thermal noise or a flicker noise is generated in active elements such as MOS transistors 260 used for the constant current sources. Here, the random noise is called the flicker noise and a component determined by a noise spectral density (current fluctuation) indicated by the following expression will be described.

$${i}^{2} = {K}_{1} \times \frac{{I}^{a}}{{f}^{b}} \times Δ f$$

Here, I denotes a DC current, K1 denotes an element specific constant, “a” denotes a constant of 0.5 to 2, and “b” denotes a constant of about 1. If the noise spectral density is indicated using an RMS value obtained by the integration with respect to a frequency C, the following equation is obtained.

$${\int }_{0}^{∞} {i}^{2} Δ f = {\int }_{0}^{∞} {K}_{1} \times \frac{{I}^{a}}{{f}^{b}} \times Δ f$$

If the flicker noises which are generated in the constant current sources and indicated using the RMS value are given by ib1² and ib2², because the flicker noises are independent of each other, a noise is generated in an output voltage as a voltage fluctuation indicated by the following expression.

Vout²=R2²×(ib1²+ib2²)

The noise component and the frequency f are in an inverse proportional relationship and the noise component is mainly observed as a low frequency noise component. In the conventional MOS sensor, the pixels are read out in the horizontal direction at the pixel reading rate and read out in the vertical direction at a reading rate whose unit is a period for reading one row. Therefore, the unevenness in noise is caused in the vertical direction of the screen image, which being a factor that deteriorates an image quality.

### SUMMARY OF THE INVENTION

An object of the present invention is to provide an image pickup element having a gain variable amplifier, with which deterioration in performance of the gain amplifier is prevented and an increase in cost due to an increase in chip area is suppressed.

Also, another object of the present invention is to provide a high performance differential amplifying circuit.

In order to attain the above-mentioned object, an image pickup element according to an embodiment of the present invention, including: a plurality of pixels that pick up an object image; a gain variable amplifying means that amplifies signals from the plurality of pixels; and a semiconductor substrate on which the plurality of pixels and the gain variable amplifying circuit are formed, wherein the amplifying means includes a first amplifying means that amplifies the signals from the plurality of pixels and a second amplifying means that amplifies a signal from the first amplifying means and is connected in series with the first amplifying means, and wherein a gain of the first amplifying means is switched at every first multiple and a gain of the second amplifying means is switched at every second multiple different from the first multiple.

Further, in order to attain the above-mentioned object, a differential amplifying circuit according to an embodiment of the present invention, which includes a first input element to which a first signal is input, a second input element to which a second signal is input, and a constant current circuit that drives the first input element and the second input element; and outputs a differential signal between the first signal input to the first input element and the second signal input to the second input element, wherein the first input element and the constant current circuit are connected with each other through a first resistor element, the second input element and the constant current circuit are connected with each other through a second resistor element, and wherein an end of the first resistor element which is located on an opposite side to the first input element and an end of the second resistor element which is located on an opposite side to the second input element are connected with the constant current circuit.

Other objects and features of the present invention are will appear more fully from the specification and the drawings.

### BRIEF DESCRIPTION OF THE DRAWINGS

FIG. 1 is a diagram showing an image pickup element;

FIG. 2 is an explanatory diagram of a reading circuit of the image pickup element;

FIG. 3 is a chart showing a timing of reading of the image pickup element;

FIG. 4 is a diagram showing a conventional gain variable amplifying circuit;

FIG. 5 is an explanatory graph showing an example of gain switching;

FIG. 6 is a schematic structural diagram of a conventional MOS sensor;

FIG. 7 is a schematic structural diagram of a differential amplifying circuit used for the conventional MOS sensor;

FIG. 8 is a timing chart showing a method of driving the conventional MOS sensor;

FIG. 9 is a diagram showing a gain variable amplifying circuit;

FIG. 10 is a diagram showing a gain variable amplifying circuit;

FIG. 11 is a diagram showing an image pickup element;

FIG. 12 is a chart showing a timing of serial communication in the image pickup element shown in FIG. 3;

FIG. 13 is a block diagram showing a schematic structure of a MOS sensor as a solid-state image pickup device according to an embodiment of the present invention;

FIG. 14 is schematic structural diagram of a differential amplifying circuit used for the MOS sensor as the solid-state-image pickup device according to the embodiment of the present invention; and

FIG. 15 is a diagram showing an image pickup device.

### DESCRIPTION OF THE PREFERRED EMBODIMENTS

### Embodiment 1

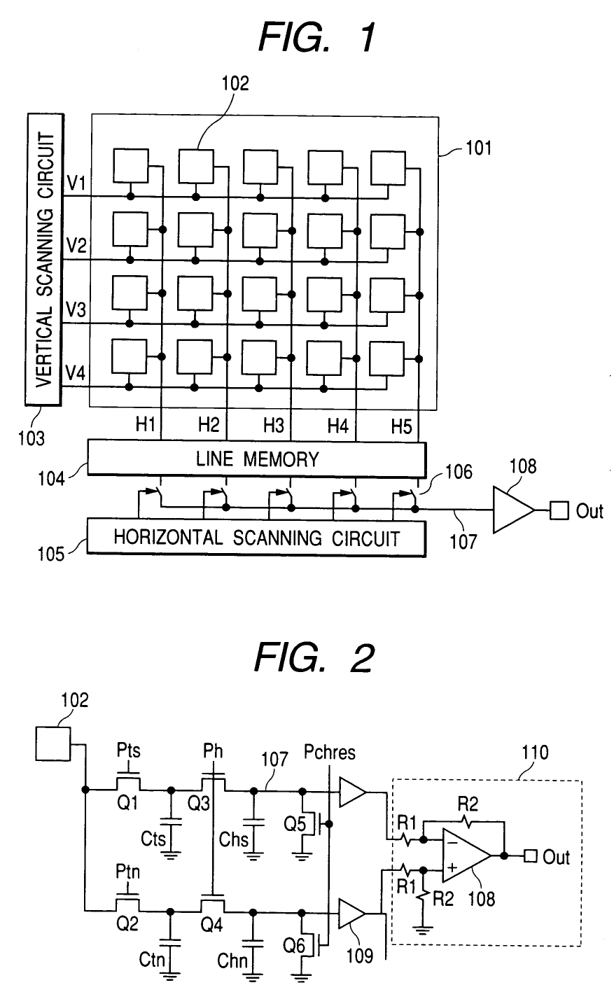

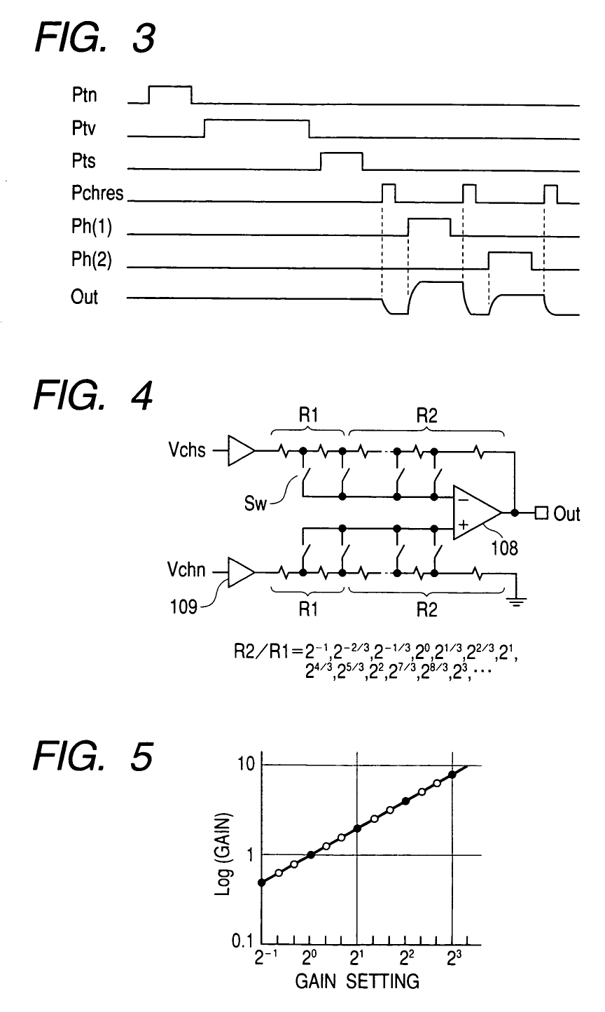

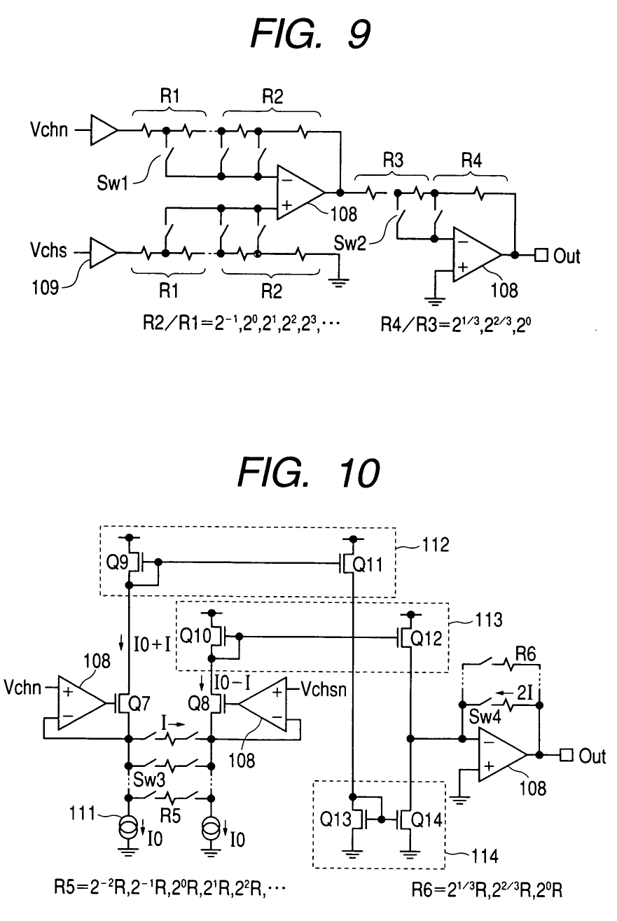

FIG. 9 is a diagram showing a gain variable amplifying circuit formed on the same semiconductor substrate together with a plurality of pixels for picking up a subject image. The amplifying circuit is located in the region denoted by 110 of the readout circuit (FIG. 2) of the image pickup element shown in FIG. 1.

In FIG. 9, as in FIG. 4, the reading block for reading from the line memory section to the common output lines is omitted and only the section located after the buffer amplifiers 109 is shown. A difference between FIG. 9 and FIG. 4 is that in FIG. 9, an inverting amplifier which is a second amplifying unit composed of a second operational amplifier 108, a plurality of resistor elements R3 and R4, and switches Sw2 is connected in series with a subtracter which is a first amplifying unit composed of a first operational amplifier 108, a plurality of resistor elements R1 and R2, and switches Sw1.

According to this embodiment, an output voltage Vout is expressed as follows:

Vout=(Vchn−Vchs)×(R2/R1)×(R4/R3) (5).

That is, a gain in a gain variable amplifier section is obtained by the following equation:

Gain=(R2/R1)×(R4/R3) (6).

In this case, if values of R2/R1 and R4/R3, which are selected by the switches Sw1 and the switches Sw2, are set so as to satisfy the following equations:

R2/R1=2⁻¹, 2⁰, 2¹, 2², 2³, (7); and

R4/R3=2^{1/3}2^{2/3}, 2⁰, (8)

it is possible to set a gain in a range of 2⁻¹ to 2³ at every 2^{1/3} times by eight combinations of the resistor elements and the switches. For example, if it is desired to set a total gain to 2^{4/3}, a gain R2/R1 of the first stage and a gain R4/R3 of the next state may be set to 2¹ and 2^{1/3}, respectively, so as to satisfy the following equation:

(R2/R1)×(R4/R3)=2¹×2^{1/3}=2^{4/3} (9).

As a result, a desirable gain can be obtained.

As described above, in the case where it is constructed such that the gain of the first stage is switched at a multiple of 2 and the gain of the next stage is switched at a switching width of 2^{1/3} which is smaller than that of the first stage and the first stage and the next stage are cascaded, gain setting can be realized by the number of resistor elements and the number of switches which are smaller than those in the above-mentioned conventional example. Note that, for simple description, the example in which the gain is set at every 2^{1/3} times is used in this embodiment. However, the present invention is not limited to the example. For example, if the gain is to be set at every 2^{1/6} times narrower than that in the example, gain switching units of three stages are prepared, and it is constructed such that the gain of the first stage is switched at a multiple of 2, the gain of the second stage is switched at 2^{1/2}, and the gain of the third stage is switched at 2^{1/3}, and the first stage, the second stage, and the third stage are connected in series.

### Embodiment 2

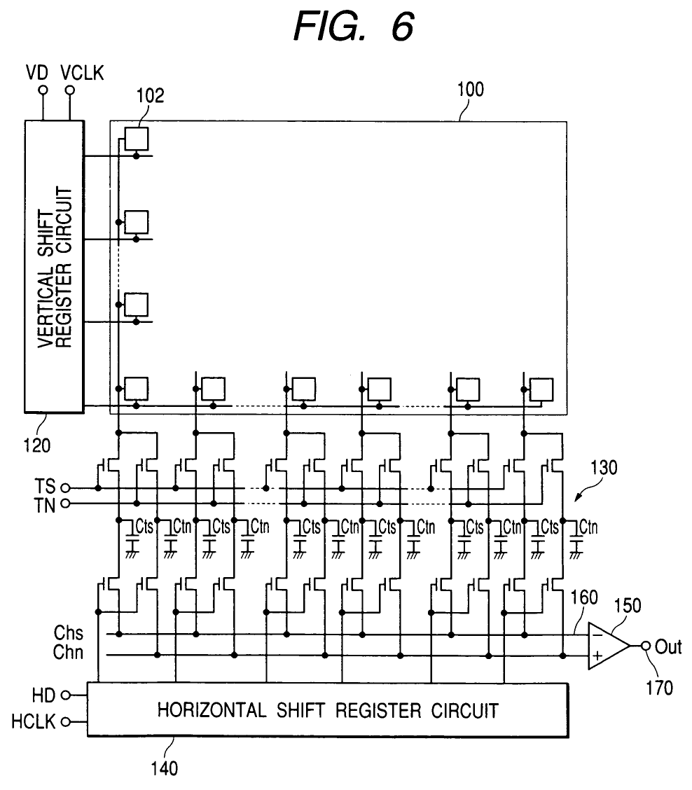

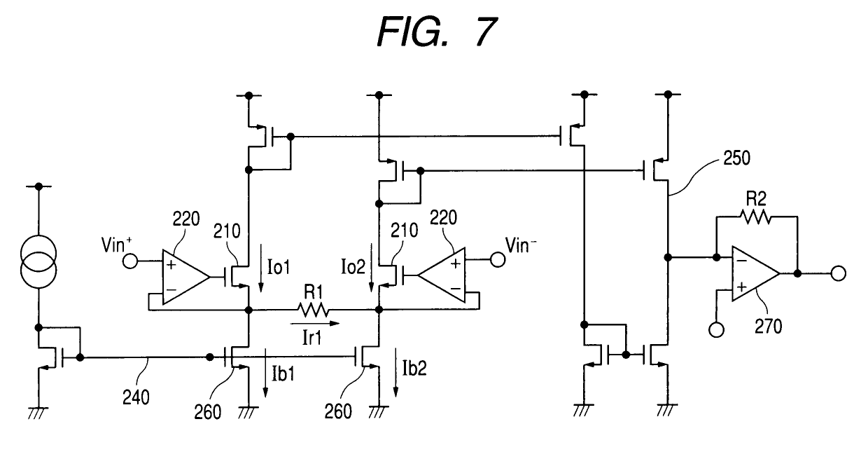

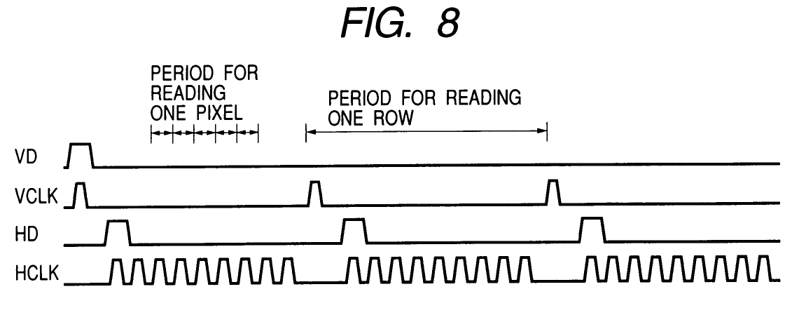

FIG. 10 shows Embodiment 2 of the present invention and is a diagram showing a gain variable amplifying circuit formed on the same semiconductor substrate together with a plurality of pixels for picking up an object image. The amplifying circuit is located in the region denoted by 150 of the image pickup element shown in FIG. 6.

The amplifying circuit according to this embodiment includes a first stage that converts a differential voltage between a photo-signal voltage and a reset noise into a current, a current mirror circuit, and a second stage that converts the converted current (differential current between the photo-signal and the noise) into a voltage again.

First, a reset noise Vchn and a photo-signal voltage Vchs which are read to the common output lines are input to the noninverting input terminal of a first operational amplifier 108 and the noninverting input terminal of a second operational amplifier 108, respectively. The output terminals of the respective operational amplifiers are connected with the gate electrodes of NMOS transistors Q7 and Q8. The source electrodes of the NMOS transistors Q7 and Q8 are connected with the inverting input terminals of the respective operational amplifiers 108 and constant current sources 111. In addition, the source electrodes of the NMOS transistors Q7 and Q8 are commonly connected with a plurality of resistor elements R5 through a plurality of switches Sw3. The drains of the NMOS transistors Q7 and Q8 are connected with the drains of PMOS transistors Q9 and Q10 which are an input of a first current mirror circuit 112 and an input of a second current mirror circuit 113. The drain of a transistor Q11 which is an output of the first current mirror circuit 112 is connected with the drain of an input transistor Q13 of a third current mirror circuit 114. The drain of an output transistor Q14 of the third current mirror circuit 114 is connected with the drain of a transistor Q12 which is an output of the second current mirror circuit 113 and the inverting input terminals of a third operational amplifier 108.

Therefore, a voltage is converted into a current by the first operational amplifier 108, the second operational amplifier 108, the NMOS transistors Q7, the plurality of switches Sw3, the plurality of resistor elements R5, the first current mirror circuit 112, the second current mirror circuit 113, and the third current mirror circuit 114, which compose a first amplifying unit.

A plurality of switches Sw4 and a plurality of resistor elements R6 are connected between the inverting input terminal of the third operational amplifier 108 and an output terminal thereof. Therefore, a current is converted into a voltage by the third operational amplifier 108, the plurality of switches Sw4, and the plurality of resistor elements R6, which compose a second amplifying unit.

The operation of the gain variable amplifying circuit according to this embodiment will be described in detail.

The first operational amplifier 108 and the second operational amplifier 108 buffer noninverting input terminal voltages. Accordingly, a potential difference (Vchn−Vchs) is produced between both ends of each of the resistor elements R5, thereby flowing a differential current I expressed as follows:

I=(Vchn−Vchs)/R5 (10).

An input current of the first current mirror circuit 112 and an input current of the second current mirror circuit 113 are changed to (I0+I) and (Io−I), respectively, according to the differential current. An output current (I0+I) of the first current mirror circuit 112 is input to the third current mirror circuit 114. Therefore, a differential current 2I is produced from a node at which the drain of the output transistor Q12 of the second current mirror circuit 113 is connected with the drain of the output transistor Q14 of the third current mirror circuit 114. The differential current 2I flows through the resistor elements R6 to obtain the output voltage Vout. That is, the output voltage Vout is expressed as follows:

Vout=2I×R6=2(Vchn−Vchs)×(R6/R5) (11).

As is apparent from the expression (11), a gain of the gain amplifier according to this embodiment is expressed by:

Gain=2×(R6/R5) (12).

Therefore, if the resistance values of the resistor elements R5 and R6 are set so as to satisfy the following equations:

R5=2⁻²×R, 2⁻¹×R, 2⁰×R, 2¹×R, 2²×R (13);

and

R6=2^{1/3}×R, 2^{2/3}×R, 2⁰×R (14),

gain switching in a range of 2⁻¹ to 2³ at every 2^{1/3} times is possible by eight combinations of switching of resistor elements and the switches. For example, if it is desired to set a total gain to 2^{4/3}, R5(=2⁰×R) and R6(=2^{1/3}×R) may be selected, so as to satisfy the following equation:

Gain=R6/R5=2×(2^{1/3}/2⁰)=2^{4/3} (15).

As a result, a desirable gain can be realized.

### Embodiment 3

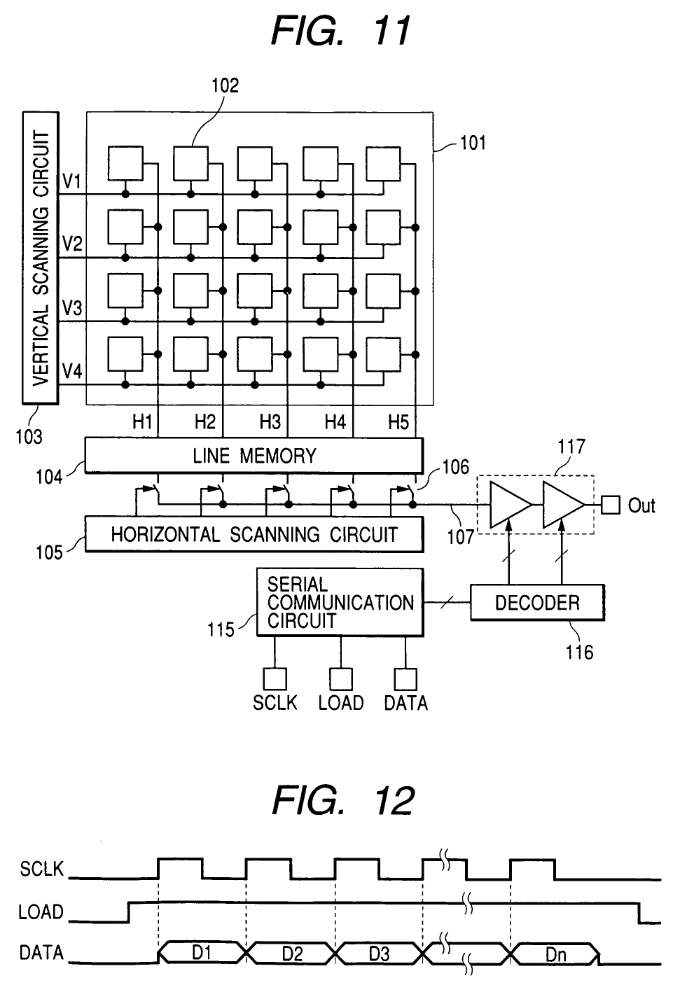

FIG. 11 is a diagram showing an image pickup element in which a gain variable amplifying circuit 117 and a plurality of pixels for picking up an object image are formed on the same semiconductor substrate.

Here, the structure of the amplifying circuit may be the same as the structure in Embodiment 1 or the structure in Embodiment 2.

As described above, the number of combinations of gain switching between 2⁻¹ and 2³ at every 2^{1/3} times is 13. Therefore, in gain switching, it is necessary to input a control signal of 4 bits from the outside. In the case where a gain switching width is further narrowed in future, the number of control terminals is further increased and this causes an increase in the chip area. A feature of this embodiment is that gain switching control is conducted by serial communication. That is, the image pickup element further includes a serial communication circuit 115 and a decoder 116 which is a converting unit that converts serial data from the serial communication circuit 115 into parallel data to obtain desirable gain switching data. The gain of the gain variable amplifying circuit 117 is switched in accordance with the output of the decoder 116. FIG. 12 is a timing chart showing pulses required for serial communication. As shown in FIG. 12, data communication is performed during a period in which a communication enable pulse LOAD is a high level. Data (DATA) is latched in synchronization with a serial communication clock SCLK. According to this embodiment, the number of control signals for gain switching is only 3. That is, only the signals SCLK, LOAD, and DATA are required. Thus, even in the case of precise gain switching, an image pickup element with which an increase in the number of control signals to be input is prevented can be provided.

### Embodiment 4

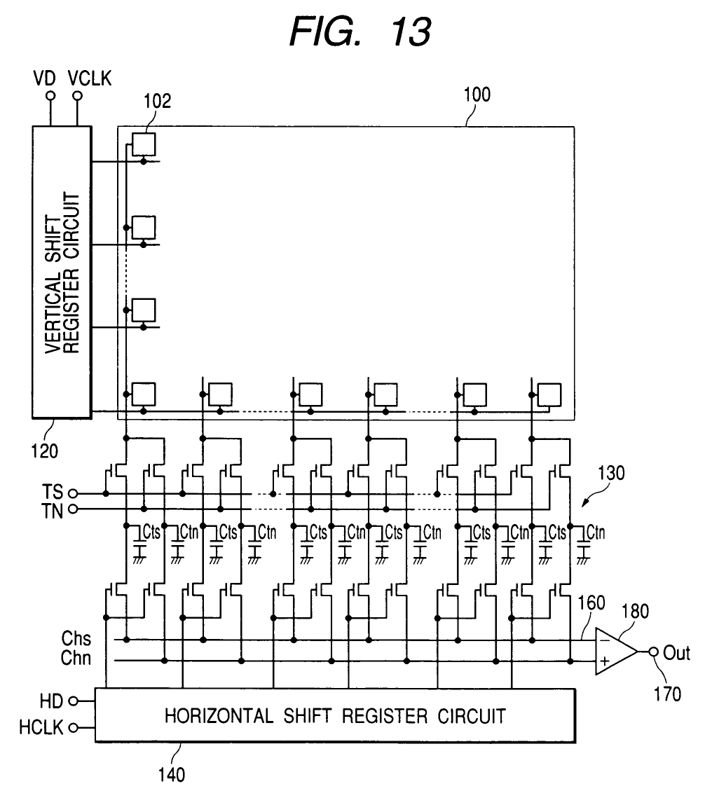

FIG. 13 is a block diagram showing a schematic structure of a MOS sensor as a solid-state image pickup device according to an embodiment of the present invention. The MOS sensor includes a sensor array 100, a vertical shift register circuit 120, a line memory circuit 130, a horizontal shift register circuit 140, and a differential amplifying circuit 180. A plurality of photoelectric conversion elements 102 are two-dimensionally arranged in the sensor array 100. The vertical shift register circuit 120 successively selects a row from the sensor array 100. The line memory circuit 130 includes signal charge holding capacitors Cts that hold signal charges (S) from the photoelectric conversion elements 110 of the selected row and reset level holding capacitors Ctn that hold reset levels (N) therefrom. The horizontal shift register circuit 140 successively transfers the signal charges and the reset revels of one row, which are held in the line memory circuit 130, through an S-side common output line and an N-side common output line. The differential amplifying circuit 180 amplifies a differential signal of signals (signal charge and the reset revel) transferred to the S-side common output line and the N-side common output line and outputs the amplified signal.

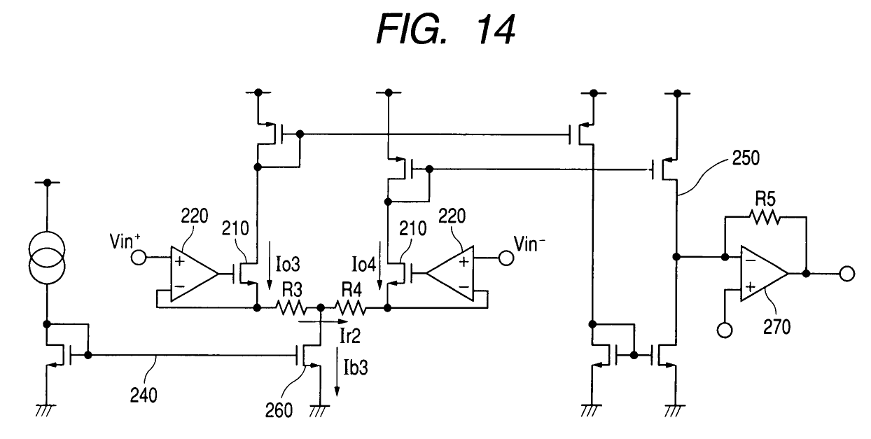

FIG. 14 is schematic structural diagram of the differential amplifying circuit used for the MOS sensor as the solid-state image pickup device according to the embodiment of the present invention. The differential amplifying circuit includes two buffer circuits 220, a first resistor element R3, a second resistor element R4, and a constant current source for driving an input differential pair. The two buffer circuits 220 are composed of operational amplifiers having output stages in which respective MOS transistors 210 which are a first input element and a second input element are connected to obtain a follower structure. The first resistor element R3 and the second resistor element R4 which have an identical resistance value and are connected in series are inserted between the input terminals of the buffer circuits 220. The constant current source that drives the input differential pair is composed of a MOS current mirror circuit (constant current circuit) 240. In addition, the differential amplifying circuit is constructed to supply a current from only a connection point of the two resistor elements R3 and R4.

Referring to FIG. 14, differential input voltages Vin+ and Vin− are applied to both ends of the resistor elements R3 and R4 connected between the output terminal of the buffer circuits 220, and thus a current Ir2(=(Vin+−Vin−)/(R3+R4)) is generated, so that currents Io3(=½×Ib3+Ir2) and Io4(=½×Ib3−Ir2) are obtained from the drain terminals in the output stages of the buffer circuits 220. Subsequently, a differential value of input currents (Io1−Io2=½×Ib3−½×Ib3+2×Ir2=2×Ir2) from the two buffer circuits 220, which is obtained by a differential current extracting unit 250 is converted into an output voltage Vout(=R5×(Io3−Io4)=R5×2×(Vin+−Vin−)/(R3+R4)) by a current-voltage conversion unit 270 in accordance with the voltage supplied to the positive input terminal of the current-voltage conversion unit 270 and Vout is output therefrom. That is, the output voltage is determined by the resistance values of the resistor elements R3 and R4 located in the input stage and the output stage of the differential amplifying circuit and the differential input voltages as in the conventional example.

Here, a flicker noise generated in the constant current source is considered as in the conventional example. If the flicker noise which is generated in the constant current source and indicated using the RMS value is given by ib32, an output voltage is indicated by the following expression.

$${Vout}^{2} = {R5}^{2} \times {( \frac{1}{2} \times i b3 - \frac{1}{2} \times i b3 )}^{2} = 0$$

As is also apparent from the expression, the constant current source is constructed to supply a current from only the connection point of the two resistor elements. Therefore, the flicker noise generated in the constant current source is equally divided into two and the divided noises are transmitted from the output terminals of the buffer circuits. Thus, the noises cancel each other as correlation signals, so that the output is not influenced by the noises.

As described above, according to this embodiment, the differential amplifying circuit includes the first input element which receives a first signal and is composed of one MOS transistor 210, the second input element which receives a second signal and is composed of the other MOS transistor 210, and the constant current circuit that drives the first input element and the second input element and is composed of the MOS current mirror circuit 240. The differential amplifying circuit outputs a differential signal between the first signal input to the first input element and the second signal input to the second input element. The first input element and the constant current circuit are connected with each other through the first resistor element. The second input element and the constant current circuit are connected with each other through the second resistor element. Further, the end of the first resistor element which is located on an opposite side to the first input element and the end of the second resistor element which is located on an opposite side to the second input element are connected with the constant current circuit. Thus, random noises can be reduced.

Also, the example in which the differential amplifying circuit is applied to the solid-state image pickup device is described in this embodiment. However, the differential amplifying circuit may be applied to devices other than the solid-state image pickup device.

### Embodiment 5

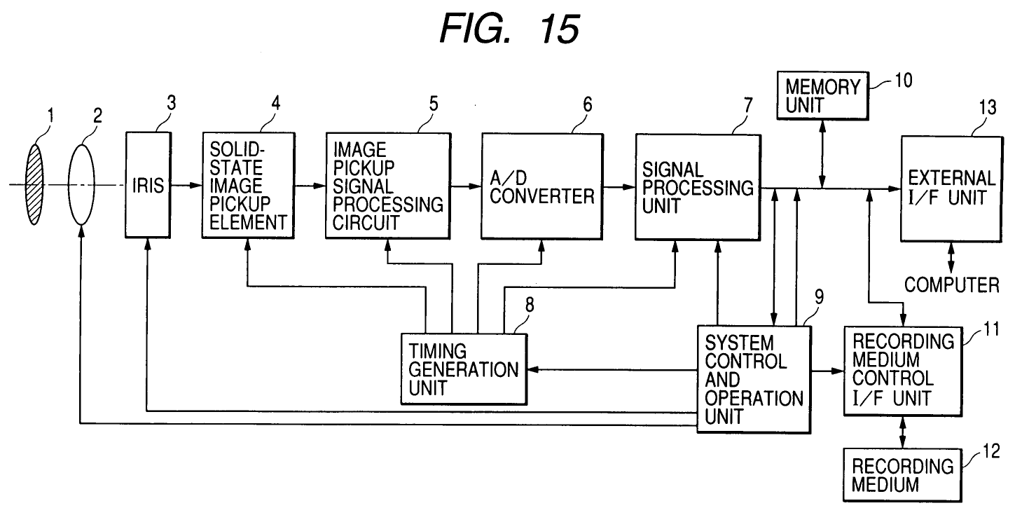

An image pickup device using the image pickup element described in Embodiments 1 to 4 will be described with reference to FIG. 15.

In FIG. 15, reference numeral 1 denotes a barrier that protects a lens and also serves as a main switch, 2 denotes a lens that images an optical image of an object onto a solid-state image pickup element 4, 3 denotes an iris capable of adjusting the amount of light transmitting through the lens 2, and 4 denotes the solid-state image pickup element that obtains the optical image of the object imaged by the lens 2 as an image signal. In addition, reference numeral 5 denotes an image pickup signal processing circuit including a gain variable amplifier section that amplifies the image signal output from the solid-state image pickup element 4 and a gain correcting circuit section that corrects a gain value, 6 denotes an A/D converter that converts the analog image signal output from the solid-state image pickup element 4 into digital image data, and 7 denotes a signal processing unit that performs various corrections and data compression on the image data output from the A/D converter 6. Further, reference numeral 8 denotes a timing generation unit that outputs various timing signals to the solid-state image pickup element 4, the image pickup signal processing circuit 5, the A/D converter 6, and the signal processing unit 7, 9 denotes a system control and operation unit that performs various operations and controls on the entire still video camera, and 10 denotes a memory unit that temporarily stores the image data. Furthermore, reference numeral 11 denotes a recording medium control interface unit that performs recording to or reading from a recording medium, 12 denotes the attachable recording medium that performs recording of the image data or reading thereof, such as a semiconductor memory, and 13 denotes an external interface unit that communicates with an external computer and the like.

Next, the image pickup operation of a still video camera using the above-mentioned structure will be described.

When the barrier 1 is opened, a main power source is turned on. Next, a control power source is turned on and then a power source for an image pickup circuit such as the A/D converter 6 is turned on.

Then, in order to control the amount of exposure, the system control and operation unit 9 causes the iris 3 to open. The signal output from the solid-state image pickup element 4 is converted into a digital signal by the A/D converter 6 and then input to the signal processing unit 7.

The operation of the exposure is performed by the system control and operation unit 9 in accordance with the data.

Brightness is determined from a result obtained by the photometry and the system control and operation unit 9 controls the iris 3 according to the result.

Next, a high frequency component is extracted from the signal output from the solid-state image pickup element 4 and the operation of a distance of up to the subject is performed by the system control and operation unit 9. After that, the lens 2 is driven and it is determined whether or not the lens 2 is focused. If it is determined that the lens 2 is not focused, the lens 2 is driven again and the distance measurement is performed.

After the focusing is ensured, the main exposure starts.

After the exposure is completed, the analog image signal output from the solid-state image pickup element 4 is converted into a digital signal by the A/D converter 6 and written into the memory unit 10 by the system control and operation unit 9 through the signal processing unit 7.

After that, the data stored in the memory unit 10 is recorded on the attachable recording medium 12 such as a semiconductor memory by the control of the system control and operation unit 9 through the recording medium control I/F unit 11.

Also, the data stored in the memory unit 10 may be directly input to a computer and the like through the external I/F unit 13 to perform image processing.

Many widely different embodiments of the present invention may be constructed without departing from the spirit and scope of the present invention. It should be understood that the present invention is not limited to the specific embodiments described in the specification, except as defined in the appended claims.

What is claimed is:

1. An image pickup element comprising:
a plurality of pixels that pick up an object image;
a gain variable amplifying circuit that amplifies a signal from the plurality of pixels; and
a semiconductor substrate on which the plurality of pixels and the gain variable amplifying circuit are formed,
wherein the gain variable amplifying circuit comprises a first amplifying circuit that amplifies the signal from the plurality of pixels and a second amplifying circuit that amplifies a signal from the first amplifying circuit and is connected in series with the first amplifying circuit, and
wherein a gain of the first amplifying circuit is switched at every first multiple and a gain of the second amplifying circuit is switched at every second multiple different from the first multiple.

2. An image pickup element according to claim 1, further comprising:
an input terminal to which a control signal for gain switching of the amplifying circuit is input from an outside of the image pickup element; and
converting means for converting a time series signal from the input terminal into a parallel signal,
wherein the amplifying circuit is controlled in accordance with the parallel signal from the converting means.

3. An image pickup element according to claim 1, wherein the first amplifying circuit is a voltage-current conversion circuit that converts a voltage into a current and outputs the converted current, and the second amplifying circuit is a current-voltage conversion circuit that converts the current into a voltage and outputs the converted voltage.

4. An image pickup device comprising:
an image pickup element according to claim 1;
a lens that images light onto the image pickup element;
an analog-digital conversion circuit that converts a signal from the amplifying circuit into a digital signal; and
a signal processing circuit that processes the digital signal from the analog-digital conversion circuit.

5. A differential amplifying circuit comprising:
a first input element to which a first signal is input;
a second input element to which a second signal is input; and
a constant current circuit that drives the first input element and the second input element,
wherein the differential amplifying circuit outputs a differential signal between the first signal input to the first input element and the second signal input to the second input element, and
wherein the first input element and the constant current circuit are connected with each other through a first resistor element, the second input element and the constant current circuit are connected with each other through a second resistor element, an end of the first resistor element which is located on an opposite side to the first input element and an end of the second resistor element which is located on an opposite side to the second input element are connected with the constant current circuit.

6. A differential amplifying circuit according to claim 5, wherein the first input element comprises a first transistor whose control electrode receives the first signal, the second input element comprises a second transistor whose control electrode receives the second signal,
the differential amplifying circuit further comprising:
a first operational amplifier whose output portion is connected with the control electrode of the first transistor and whose input portion is connected with a main electrode of the first transistor; and
a second operational amplifier whose output portion is connected with the control electrode of the second transistor and whose input portion is connected with a main electrode of the second transistor

7. An image pickup device comprising:
an image pickup region that picks up an object image; and
a differential amplifying circuit according to claim 5 or 6 that amplifies a signal from the image pickup region and outputs the signal.

8. An image pickup device according to claim 7, further comprising a signal processing circuit that processes the signal from the differential amplifying circuit.
